(19) United States
(12) Patent Application Publication
(10) Pub. No.: US 2022/0020284 A1
(43) Pub. Date: Jan. 20, 2022

(54) SYSTEM AND METHOD FOR IMPROVING LEARNING EFFICIENCY

(71) Applicant: Summit K12 Holdings, Inc., Austin, TX (US)

(72) Inventor: John P. KRESKY, Austin, TX (US)

(21) Appl. No.: 17/380,976

(22) Filed: Jul. 20, 2021

Related U.S. Application Data
(60) Provisional application No. 63/056,224, filed on Jul. 24, 2020.
(60) Provisional application No. 63/053,217, filed on Jul. 17, 2020.
(60) Provisional application No. 63/056,220, filed on Jul. 24, 2020.

(51) Int. Cl. G09B 7/08; G09B 7/06; G09B 19/06

(52) U.S. Cl. CPC G09B 7/08; G09B 19/06; G09B 7/066

(57) ABSTRACT

A system for developing a lesson plan includes a processor comprising a computer-readable medium storing instructions configured to cause the processor, upon execution of the instructions to display a practice test to a student. The processor receives inputs indicative of the student's answers to questions on the practice test. The processor automatically tabulates a mastery percentage indicative of correct answers to the questions.

### CROSS-REFERENCE TO RELATED APPLICATIONS

This application claims priority under 35 U.S.C. § 119(e) to U.S. Provisional Application No. 63/056,224, filed Jul. 24, 2020, U.S. Provisional Application No. 63/053,217, filed Jul. 24, 2020, and U.S. Provisional Application No. 63/056,220, filed Jul. 24, 2020, each of which are expressly incorporated by reference herein.

### BACKGROUND

The present disclosure relates to a system and method for improving learning efficiency.

Various states require students, for example 3^{rd}-8^{th} grade and high school students, to take yearly state assessments that cover various subject matters learned by the students. Often, some students excel at certain subjects, but are not proficient at other subjects. Given that each student is different, the needs of each student need to be addressed in preparing either individual lesson plans or class wide lesson plans. Currently, teachers follow a standard curriculum when teaching classes. Often, this curriculum does not address the need of each student or the class as a whole.

Additionally, students often struggle achieving efficiency at required vocabulary knowledge and reading. Students taught in a classroom setting are generally taught at the same pace of learning. Accordingly, students who are behind the learning curve may fall behind in a classroom setting. This is particularly problematic for students who use English as a second language. There is a need to individualize learning plans for each student based on the student's proficiency.

### SUMMARY

The present disclosure includes one or more of the features recited in the appended claims and/or the following features, which, alone or in any combination, may comprise patentable subject matter.

According to a first aspect of the disclosed embodiments, a system for developing a lesson plan includes a processor comprising a computer-readable medium storing instructions configured to cause the processor, upon execution of the instructions to display a practice test to a student. The processor receives inputs indicative of the student's answers to questions on the practice test. The processor automatically tabulates a mastery percentage indicative of correct answers to the questions. The processor outputs a lesson plan for the student. The lesson plan is organized based on the mastery percentage.

In some embodiments of the first aspect, the questions on the practice test may be based on a plurality of standards tested on a state assessment. The lesson plan may be organized based on the mastery percentage of each of the plurality of standards. The plurality of standards may include a plurality of readiness standards and a plurality of supporting standards. The lesson plan may be organized to separate the plurality of readiness standard and the plurality of supporting standards. The mastery percentage may be indicative of a percentage of questions answered correctly for each of the plurality of standards. The lesson plan may be organized so that the standards of the plurality of standards having a lower mastery percentage are given priority in the lesson plan. If a readiness standard has the same mastery percentage as a supporting standard, the lesson plan may be organized so that the readiness standard is given priority in the lesson plan. If a first of the plurality of standards has the same mastery percentage as a second of the plurality of standards, the one of the first standard and the second standard that is more frequently tested on the state assessment is given priority in the lesson plan. The processor may receive inputs indicative of a plurality of student's answers to questions on the practice test. The processor may automatically tabulate a mastery percentage indicative of correct answers to the questions by each of the plurality of students.

According to a second aspect of the disclosed embodiments, a system for improving vocabulary efficiency includes a processor comprising a computer-readable medium storing instructions configured to cause the processor, upon execution of the instructions to display a plurality of vocabulary flash cards to a student a first time. Each of the plurality of vocabulary flash cards includes a vocabulary question. The processor receives inputs indicative of vocabulary questions answered correctly by the student the first time. The processor displays the plurality of vocabulary flash cards to the student a second time. The processor receives inputs indicative of vocabulary questions answered correctly by the student the second time. The processor removes the vocabulary flash cards having the vocabulary questions that have been answered correctly both the first time and the second time to create remaining flash cards. The processor displays the remaining flash cards to the student.

In some embodiments of the second aspect, the processor may continue to display the remaining flash cards to the student until each of the vocabulary questions is answered correctly twice. An audio device may be provided. The processor may audibly transmit the vocabulary question through the audio device. The vocabulary questions may be audibly transmitted in a plurality of languages. The vocabulary questions may be displayed in a plurality of languages. The vocabulary question on each vocabulary flash card may be changed each time that the flash card is displayed. Each flash card may include an illustration associated with the vocabulary question. The illustration associated with the vocabulary question may be changed each time that the flash card is displayed.

According to a third aspect of the disclosed embodiments, a system for improving reading efficiency includes a processor comprising a computer-readable medium storing instructions configured to cause the processor, upon execution of the instructions to display a practice test to a student. The processor receives inputs indicative of the student's answers to questions on the practice test. The processor assigns a reading level to the student. The processor unlocks one of a plurality of a reading titles based on the reading level of the student.

In some embodiments of the third aspect, each of the plurality of reading titles may be classified in one of a plurality of reading levels. The processor may unlock a reading title that corresponds to one of the plurality of reading level. Each of the plurality of reading titles may be classified one of a plurality of subjects. Each of the plurality of subjects may include four reading titles, wherein each of the four reading titles classified within one of four reading levels. If the student completes the one of the plurality of reading titles, the processor may unlock a new reading title. The new reading title may be based on another reading level. The reading titles may be displayed in a plurality of languages.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a schematic view of a system for improving learning efficiency;

FIG. 2 is a table displaying a mastery percentage of various subjects for a plurality of students;

FIG. 3 is a table of a state wide mastery percentage of various subjects tested on a state assessment;

FIG. 4 is a table illustrating a lesson plan for various subjects tested on a state assessment;

FIG. 5 is a display for selecting a practice test to test a student's efficiency on various subject matters;

FIG. 6 illustrates the front side of an exemplary vocabulary flash card;

FIG. 7 illustrates the back side of an exemplary vocabulary flash card;

FIG. 8 illustrates a table of vocabulary words tested;

FIG. 9 illustrates a table of a mastery percentage of vocabulary words for various subjects;

FIG. 10 illustrates a display for testing reading efficiency;

FIG. 11 illustrates an exemplary reading title; and

FIG. 12 illustrates a vocabulary page of another exemplary reading title.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

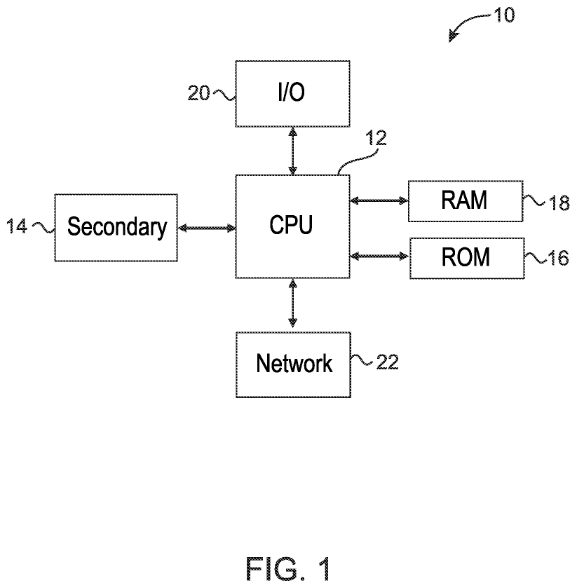

Referring to FIG. 1, a system 10 is provided for improving learning efficiency. All of, or a portion of, the system 10 may be implemented on any particular machine, or machines, with sufficient processing power, memory resources, and throughput capability to handle the necessary workload placed upon the computer, or computers. FIG. 1 illustrates a computer system 10 suitable for implementing all, or a portion of, one or more embodiments disclosed herein. The computer system 10 includes a processor 12 (which may be referred to as a central processor unit or CPU) that is in communication with memory devices including secondary storage 14, read only memory (ROM) 16, random access memory (RAM) 18, input/output (I/O) devices 20, and network connectivity devices 22. The processor 12 may be implemented as one or more CPU chips.

It is understood that by programming and/or loading executable instructions onto the computer system 10, at least one of the CPU 12, the RAM 18, and the ROM 16 are changed, transforming the computer system 10 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 14 is typically comprised of one or more disk drives or tape drives and is used for non-volatile storage of data and as an over-flow data storage device if RAM 18 is not large enough to hold all working data. Secondary storage 14 may be used to store programs, which are loaded into RAM 18 when such programs are selected for execution. The ROM 16 is used to store instructions and perhaps data, which are read during program execution. ROM 16 is a non-volatile memory device, which typically has a small memory capacity relative to the larger memory capacity of secondary storage 14. The RAM 18 is used to store volatile data and perhaps to store instructions. Access to both ROM 16 and RAM 18 is typically faster than to secondary storage 14. The secondary storage 14, the RAM 18, and/or the ROM 16 may be referred to in some contexts as computer readable storage media and/or non-transitory computer readable media.

I/O devices 20 may include monitors, printers, video monitors, speakers, liquid crystal displays (LCDs), touch screen displays, keyboards, keypads, switches, dials, mice, track balls, voice recognizers, card readers, paper tape readers, or other well-known input devices or output devices.

The network connectivity devices 22 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 22 may enable the processor 12 to communicate with the Internet or one or more intranets. With such a network connection, it is contemplated that the processor 12 might receive information from the network or might output information to the network in the course of performing the above-described method steps. Such information, which is often represented as a sequence of instructions to be executed using processor 12, may be received from and outputted to the network, for example, in the form of a computer data signal embodied in a carrier wave.

Such information, which may include data or instructions to be executed using processor 12 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 12 executes instructions, codes, computer programs, scripts which it accesses from hard disk, floppy disk, optical disk (these various disk-based systems may all be considered secondary storage 14), ROM 16, RAM 18, or the network connectivity devices 22. While only one processor 12 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 14, for example, hard drives, floppy disks, optical disks, and/or other device, the ROM 16, and/or the RAM 18 may be referred to in some contexts as non-transitory instructions and/or non-transitory information.

In an embodiment, the computer system 10 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 10 to provide the functionality of a number of servers that is not directly bound to the number of computers in the computer system 10. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 10, at least portions of the contents of the computer program product to the secondary storage 14, to the ROM 16, to the RAM 18, and/or to other non-volatile memory and volatile memory of the computer system 10. The processor 12 may process the executable instructions and/or data structures in part by directly accessing the computer program product, for example by reading from a CD-ROM disk inserted into a disk drive peripheral of the computer system 10. Alternatively, the processor 12 may process the executable instructions and/or data structures by remotely accessing the computer program product, for example by downloading the executable instructions and/or data structures from a remote server through the network connectivity devices 22. The computer program product may comprise instructions that promote the loading and/or copying of data, data structures, files, and/or executable instructions to the secondary storage 14, to the ROM 16, to the RAM 18, and/or to other non-volatile memory and volatile memory of the computer system 10.

In some contexts, the secondary storage 14, the ROM 16, and the RAM 18 may be referred to as a non-transitory computer readable medium or a computer readable storage media. A dynamic RAM embodiment of the RAM 18, likewise, may be referred to as a non-transitory computer readable medium in that while the dynamic RAM receives electrical power and is operated in accordance with its design, for example during a period of time during which the computer 10 is turned on and operational, the dynamic RAM stores information that is written to it. Similarly, the processor 12 may comprise an internal RAM, an internal ROM, a cache memory, and/or other internal non-transitory storage blocks, sections, or components that may be referred to in some contexts as non-transitory computer readable media or computer readable storage media.

The ordering of steps in the various processes, data flows, and flowcharts presented are for illustration purposes and do not necessarily reflect the order that various steps must be performed. The steps may be rearranged in different orders in different embodiments to reflect the needs, desires and preferences of the entity implementing the systems. Furthermore, many steps may be performed simultaneously with other steps in some embodiments.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed. The following numbered entries represent a non-exhaustive collection of exemplary embodiments of the instantly disclosed subject matter.

In one embodiment, the students begin by taking a full-length practice test that mimics the state assessment. The practice test may include a practice test developed by a localized school board to mimic the state assessment. In some embodiments, the practice test includes a previously administered state assessment. In some embodiments, content authors create all of the practice tests embedded within the system 10. In lieu of using the created programs, local school boards may develop and administer their own tests or use copies of formerly released state exams, but the results of those administrators may not be as effective or efficient as the programed tests. In addition to the mastery process, the system 10 includes content and assessments that are research-based and continually being updated. This content is then loaded into the system 10 to leverage the embodiments described herein.

After a student completes the practice test, the system 10 dynamically creates an optimized review plan to prepare them for optimal results on the state assessment. Some inputs may be required from teachers including the date of the state assessment, the number of instructional days left until the state assessment, and the average number of minutes per day of instruction. The system 10 then generates an optimized test preparation plan for the student based on their practice test results, the date of the state assessment, number of days left, and average number of minutes per day. The lesson plan is presented in the sequence optimized by the system 10.

The optimized plan can be generated for a class of students or for each individual student. For example, if a teacher teaches five class periods of Language Arts and the classes have different needs (i.e. Regular class, Pre-AP class, AP class, Intervention class, Special Ed class), the system 10 generates a unique optimized plan for each class based on their unique learning need vs. the teacher covering the exact same lesson each day with all of these different classes. Alternatively, the system 10 can generate an individual learning plan for each student based on their unique mastery levels and learning priorities that will optimize each individual student's success on the state assessment.

In some embodiments, accommodations are provided for special education students or English learners. During the actual state tests, these students are provided with additional support such as having the questions and answers read aloud to them, having a test with just three multiple-choice answers instead of four, or a related support. The system 10 can automatically include similar accommodations within the test preparation courses. For example, if a student is entitled to have the questions and answers read aloud, then within the student's view of the practice test, the student will receive this accommodation.

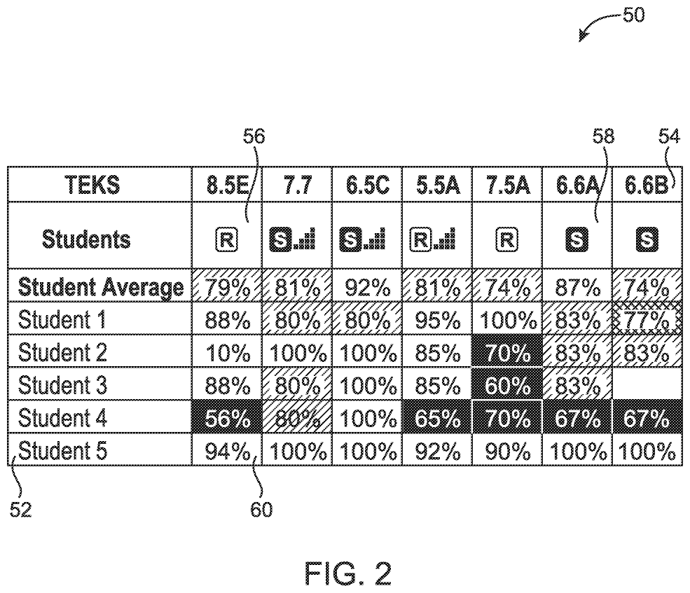

Referring now to FIG. 2, a chart 50 is generated that lists each student 52 in a class. Each student is graded on standards 54 that are identified using a code that correlates to a standard on the state assessment. The standards 54 are also categorized into one of two types of standards. A first type of standard, a Readiness Standard, includes subject matters that test a general concept. The Readiness Standards are labeled with an icon 56 that is displayed as the letter “R.” A second type of standard, a Supporting Standard, includes subject matters that test a more specific concept within a Readiness Standard. The Supporting Standards are labeled with an icon 58 that is displayed as the letter “S.” Generally, students are taught to achieve efficiency on Readiness Standards before learning corresponding Supporting Standards.

Scaffold standards 62 are also displayed as “Sc.” For example, in 5^{th} grade a student is required to learn certain standards. The scaffold is the lower grade pre-requisite or related foundational skill the student was supposed to master the year before. Most online learning systems are set up by grade level. Accordingly, if you are in 5th grade, you only see 5^{th} grade standards and lessons. The system 10 has built in lower grade scaffold lessons so the teacher and student can review lower grade related lessons to help develop the student's background knowledge so the student can access the on grade level content. Just because students are in 5^{th} grade doesn't mean the students have mastered the 3^{rd} and 4^{th} grade standards at the same level. The system 10 allows a teacher to dynamically differentiate the instruction to help students get caught up on lower grade scaffolds to 3 grades lower as needed (struggling learner, english learner, special Ed).

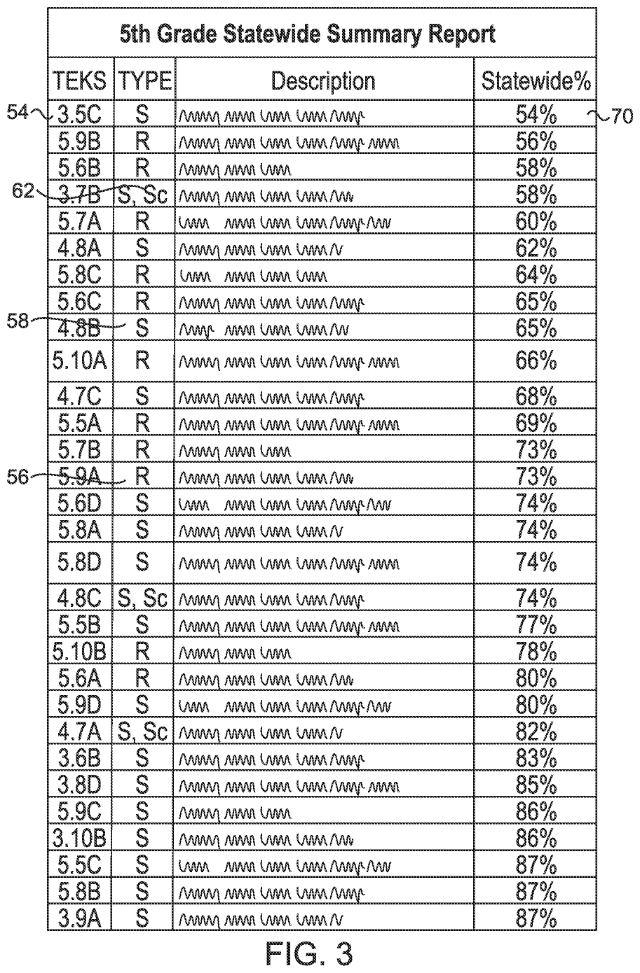

Each student receives a mastery percentage score 60 that indicates a percentage of questions from the practice test answered correctly for each standard 54. For an individual lesson plan, the mastery percentage score 60 for each individual student may be utilized to organize the lesson plan. For a class-wide lesson plan, the average mastery percentage score 60 of all of the students may be utilized to organize the lesson plan. In some embodiments, a statewide mastery percentage score 70 for each standard 54, as shown in FIG. 3, may be included when the lesson plan is developed. For example, the student's mastery percentage score 60 for each standard 54 may be averaged with the statewide mastery percentage score 70 for each standard 54. In some embodiments, the student's mastery percentage score 60 for each standard 54 may be weighed against the statewide mastery percentage score 70 for each standard 54. In some embodiments, if a standard 54 is not included on the practice test, then the statewide mastery percentage score 70 from the previous year's state assessment is used as a substitute mastery percentage score 60.

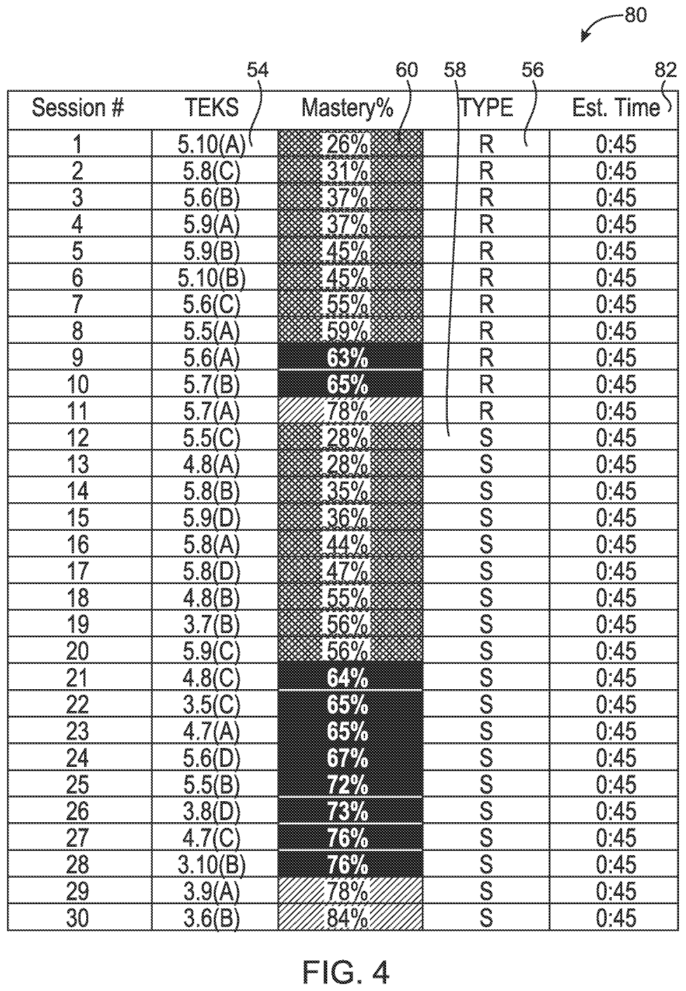

The system 10 generates a lesson plan 80, as shown in FIG. 4 that emphasizes standards 54 where the students are not as proficient. For example, standards 54 that have a lower mastery percentage score 60 are organized in the lesson plan 80 to be taught to the students first. The lesson plan 80 factors the number of days remaining until the state assessment and the time 82 available for each standard 54. The lesson plan 80 is organized so that the Readiness Standards 56 are taught to the students prior to teaching the Supporting Standards 58. Additionally, when a mastery percentage score 60 for two standards 54 is the same, the standard 54 that is more frequently tested on the assessment is taught first. For example, the standard 54 that has been tested more frequently on the state assessment over the last six years is taught before a standard 54 that is tested less frequently.

Each question on the state assessment as well as the practice test are aligned to a specific Readiness Standard or Supporting Standard. The lesson plan 80 will prioritize Readiness Standards 56 ahead of Support Standards 58, unless a student scored 80% or better on a Readiness Standard on the practice test. In this case, a lower mastery percentage score for a Supporting Standard would be included earlier in the lesson plan 80. The system 10 takes into consideration the frequency a particular standard has been seen on the past 6 years of state assessments. If a student scores a 65% on two Readiness Standards on the practice test, then to break the tie in terms of which standard (or concept) 54 should be reviewed first, the system 10 looks at the frequency distribution chart to see which standard has been included more frequently. This standard 54 is then moved up on the lesson plan 80. The practice test does not include 100% of the tested standards for the course (similar to the actual state assessment). If a particular standard 54 is not included in the practice test, the system 10 looks at the previous year's state report to determine an appropriate rank for this standard. The state report also analyzes all state assessment results in the state and shows the lowest mastery percentage 80 across the state. This serves as a valid and accurate “substitute” reference point for this standard 54 in lieu of not having the standard 54 tested on the practice test.

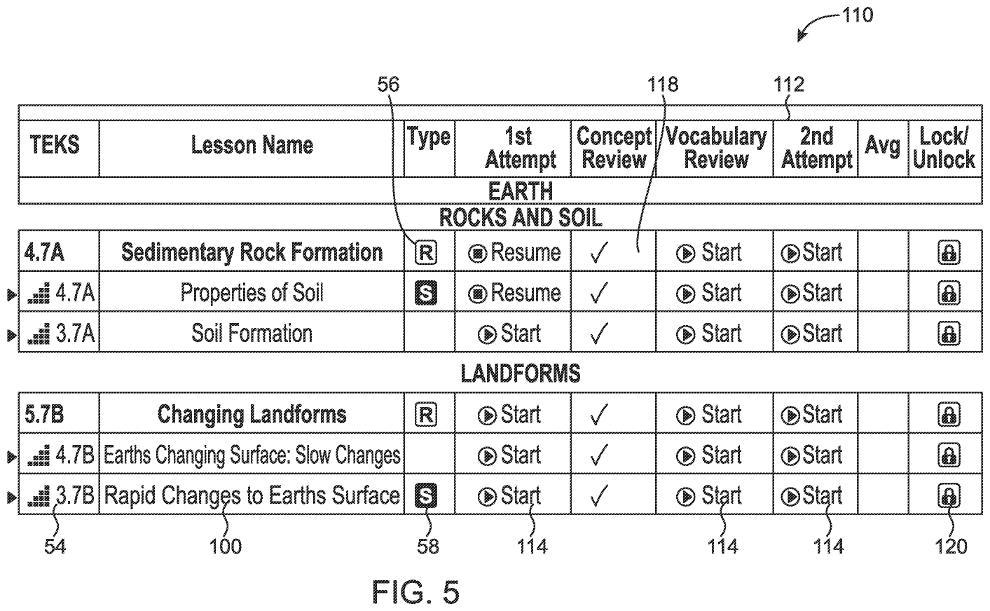

Referring now to FIG. 5, The system 10 has the ability to include scaffold lessons 100 at the discretion of the teacher. These scaffold lessons 100 are included in the lesson plan 80 if the student scores below a 70% on a standard 54 for which the scaffold 100 supports. The student completes the scaffold lessons 100 to prepare the student for the standard 54. A display 110 includes a table 112 of standards 54 to be taught with scaffold lessons 100. An input 114 enables the student to begin lesson 100 for each standard 54. The input 114 may display the word “start” to begin the lesson 100 or the word “resume” to resume the lesson 100. A check mark 118 indicates that the lesson 100 has been completed. The teacher may lock or unlock each lesson 100 by selecting an icon 120.

In general, the system 10 follows the below method. The system 10 displays a practice test to a student. The questions on the practice test are based on a plurality of standards 54 tested on a state assessment. The plurality of standards 54 include a plurality of Readiness Standards and a plurality of Supporting Standards. The system 10 receives inputs indicative of the student's answers to questions on the practice test. The system 10 automatically tabulates a mastery percentage 60 indicative of correct answers to the questions. The mastery percentage 60 is indicative of a percentage of questions answered correctly for each of the plurality of standards. The system 10 outputs a lesson plan 80 for the student that is organized based on the mastery percentage 60. The lesson plan 80 is organized based on the mastery percentage 60 of each of the plurality of standards 54. The lesson plan 80 is organized to separate the plurality of Readiness Standards 56 and the plurality of Supporting Standards 58. The lesson plan 80 is organized so that the standards of the plurality of standards 54 having a lower mastery percentage 60 are given priority in the lesson plan 80. If a Readiness Standard 56 has the same mastery percentage 60 as a Supporting Standard 58, the lesson plan 80 is organized so that the Readiness Standard 56 is given priority in the lesson plan 80. If a first of the plurality of standards 54 has the same mastery percentage 60 as a second of the plurality of standards 54, the one of the first standard 54 and the second standard 54 that is more frequently tested on the state assessment is given priority in the lesson plan 80. In some embodiments, the system 10 receives inputs indicative of a plurality of student's answers to questions on the practice test. The system 10 automatically tabulates a mastery percentage 60 indicative of correct answers to the questions by each of the plurality of students.

The system 10 provides a unique, dynamic, customized and personalized lesson plan 80, so each student will have an opportunity to achieve their highest potential on the state assessment. The system optimizes the instructional priorities based on the number of instructional days left until the state test. The system prioritizes daily lessons and instruction based on recent assessment, number of instructional days left, the need for scaffold lessons 100, the need for special accommodations, the frequency that the standard 54 has been included on the state test over the last 6 years, the weight of the standard's importance on the state assessment, e.g. Readiness=66% of questions; Supporting=33% of questions, and the previous year's ranking of all standards 54 tested. The system 10 provides a unique process that enables students to master each standard during each day of the review cycle. In some embodiments, the system 10 provides each student with a personalized 30, 45, or 60 day lesson plan 80 generated before the state assessment. The student follows the lesson plan 80 in order to optimize their potential on the state assessment.

In another embodiment, the system 10 provides tests for improving vocabulary efficiency through a dynamic, personalized, real-time vocabulary mastery process that includes teaching over 15,000 K-12 academic vocabulary words. In some embodiments, the vocabulary words include K-12 math vocabulary words; K-12 English language arts vocabulary words; K-12 science vocabulary words; K-12 science process and science tools vocabulary words; K-12 social studies vocabulary words; abstract nouns vocabulary words; thinking words in K-12 in Science, K-12 social studies, K-12 math, and K-12 language arts; and K-12 vocabulary words in Spanish.

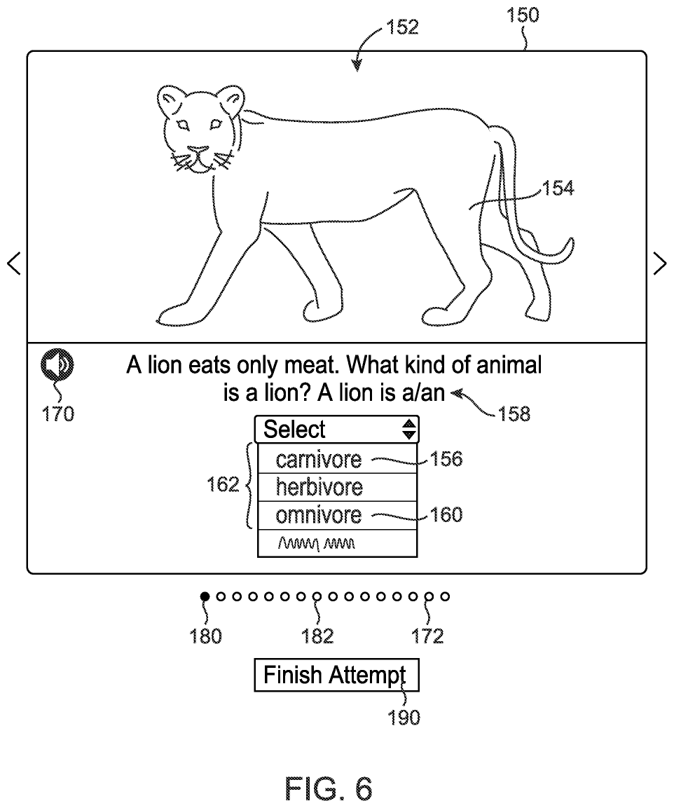

FIG. 6 illustrates the front side 152 of an exemplary vocabulary flash card 150 utilized to teach students various vocabulary words. The flash card 150 includes an illustration 154 indicative of the vocabulary word 156 being tested. A sentence 158 that includes a drop down menu 160 inserted into the sentence where the vocabulary word 156 is to be used. By selecting the drop down menu 160 a plurality of words 162 are presented that include the vocabulary word 156 being tested. The student uses an input device, for example, a mouse, to select the correct word that completes the sentence 158. In some embodiments, an audio icon 170 enables the student to listen to the sentence 158 through an audio device. The sentence 158 may be read in English or any of a plurality of languages that correspond to first language of the student. Icons 172 below the illustration 154 indicate which flash card 150 in a series of flash cards 150 that the student is viewing. For example, if the student is viewing the first flash card 150 in a series of 16 flash cards 150, the first 180 of 16 buttons 182 is highlighted. After the student selects an answer from the drop down menu 160, the student may select a “Finish Attempt” icon 190 to submit the student's answer and move to the next flash card 150.

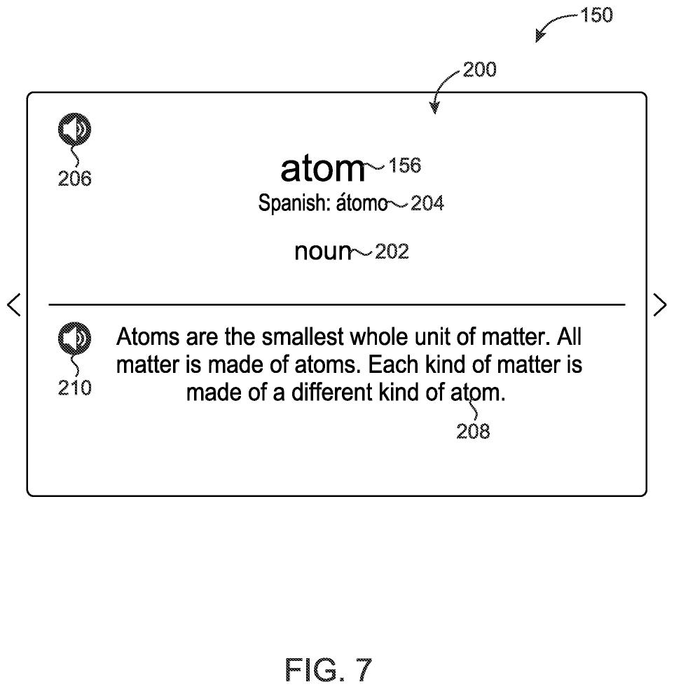

FIG. 7 illustrates the back side 200 of an exemplary vocabulary flash card 150. The back side 200 of the flash card 150 may be presented after the student enters an answer. The back side 200 of the flash card 150 illustrates the vocabulary word 156 and the type 202 of word, e.g. noun, verb, adjective, etc. The vocabulary word 156 may also be presented in a second language 204, for example, the student's first language. An audio icon 206 may be selected so that the student can hear the vocabulary word 156 in both English and/or the second language. A definition 208 is provided below the vocabulary word 156. Another audio icon 210 may be selected so that the student can hear the definition 208 in English and/or the second language.

A plurality of flash cards 150 are presented to the student during each test. The order of drop-down answers are randomized, as is the order of the flash cards 150 for each attempt and for each student. In some embodiments, the illustrations 154 and content being presented for each vocabulary word 156 is randomized for each test. If the student answers the question on the flash card 150 correctly, the student is considered to have mastered the vocabulary word 156. If the vocabulary word 156 is selected correctly two times in a row, the corresponding flash card 150 is removed from the test for all future attempts. In some embodiment, the flash card 150 is removed for correct answers within a 30-day window. If a word is incorrect, the student flips the flash card 150 over to the back side 200 and may play audio for the word and/or play the audio for the answer, before flipping the flash card 150 back over and moving to the next flash card 150. The remaining flash cards 150 that have been answer incorrectly are then presented to the student again in another attempt. Each attempt after the second attempt may has fewer flash cards until mastery of each vocabulary word 156 is achieved.

In summary, flash card groups may contain anywhere from 3-25 flash cards 150. Each student will be presented with the flash cards 150 in a random order. Each successive attempt also randomizes the order to facilitate reducing the incidence of cheating and the ability for students to memorize the sequence from one attempt to the next. Drop-down answer choices 162 appear in a random order for each student and for each successive attempt. In some embodiments, some of the wrong answer choices may be altered on each successive attempt. For example, the second attempt could replace the three alternative answers with 1-3 other wrong answers. The images and the question on the front 152 of a flash card 150 for the may be randomized for the same vocabulary word. This dynamic randomization could occur for the same student from one attempt to the next and could be randomized across all students within a class, so that one student sees a first illustration 154 on the first attempt, while another student sees a second illustration 154. The randomization helps lead to mastery because the students are no longer memorizing images or questions as they process vocabulary within a course. In some embodiments, it is recommend that the student write the word and definition for each missed word.

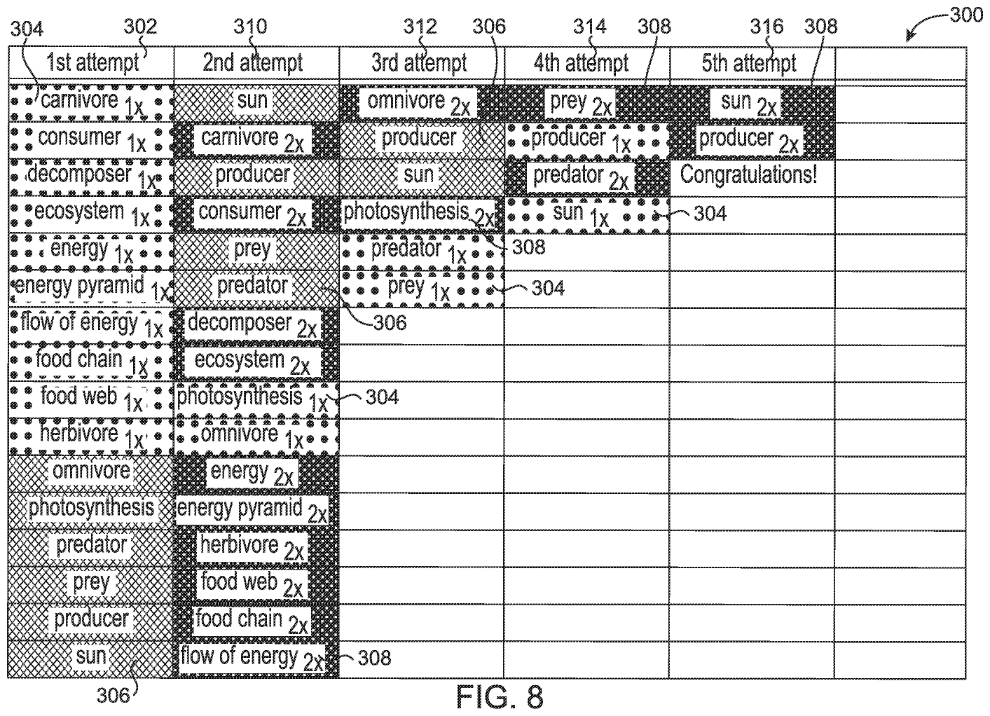

After submission, a list of correct words and incorrect words is presented in a table 300, for example, the table 300 shown in FIG. 8. The table 300 includes a column 302 of vocabulary words tested in a first attempt. The vocabulary words 154 answered correctly a first time are highlighted in a first color 304 and the vocabulary words 154 answered incorrectly the first time are highlighted in a second color 306. Each vocabulary word 154 is then tested in a second attempt. The column 310 illustrates the vocabulary words 154 tested in the second attempt. The vocabulary words 154 answered correctly in two successive attempts are highlighted in a third color 308. These vocabulary words 154 are then removed from each additional attempt. The vocabulary words 154 answered correctly only once are highlighted in the first color 304 and the vocabulary words 154 still answered incorrectly the first time are highlighted in the second color 306. Additional attempts are shown in columns 312, 314, and 316. The student continues to attempt each of the vocabulary words 154 until each vocabulary word 154 is answered correctly two times in a row.

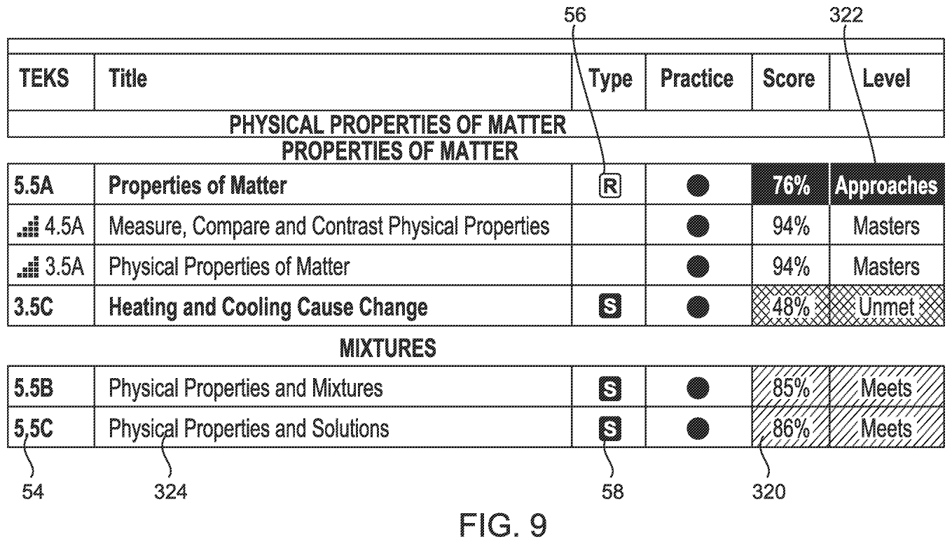

As shown in FIG. 9, students can track and monitor their mastery percent 320 for each set 324 of flash cards 154. The students are also assigned a level of mastery 322 that may include “unmet,” “approaches,” “meets,” or “masters.” The students are given unlimited attempts to reach mastery. Teachers are given access to class summary reports of mastery by student. Through the reports, the teachers gain real-time insights into vocabulary mastery across the district by subject, by grade, by school, by class, and by student. The reports may include class reports; teacher reports that may include multiple class periods; school reports by subject, by grade level, by standard, and/or by teacher; district reports by school, by subject, by grade level, by standard, and by teacher; and analysis of attempts taken to correctly answer each vocabulary word 154 by subject, grade level, school, teacher, class, and student level that ranks the vocabulary words by the number of attempts it takes students to reach mastery. This provides a high priority list of vocabulary words that students struggle with the most. Percent completion reports may track the percent progress through a particular course of standard 54. For example, if there are 25 standards 54 in science, and on average, students have completed 15 of the 25 standards 54, the report will show that students are 60% complete with the science vocabulary standards and it will display their average score to date.

The report may illustrate first attempt percent correct by student ranked lowest to highest standard 54. The report may illustrate first attempt percent correct average by class ranked lowest to highest by standard 54. The report may illustrate first attempt percent correct average by school ranked lowest to highest by standard 54. The report may illustrate first attempt percent correct average by district ranked lowest to highest by standard 54. In some embodiments, the reports are filterable by grade level. Other filters may include subject, school, teacher, class, student individual by standard 54, reporting category average, and standard average.

Overall, the system 10 facilitates improving vocabulary efficiency by displaying a plurality of vocabulary flash cards 150 to a student a first time. Each of the plurality of vocabulary flash cards 150 includes a vocabulary question. In some embodiments, the system 10 audibly transmits the vocabulary question through an audio device. The vocabulary questions may be audibly transmitted in a plurality of languages. The vocabulary questions may also be displayed in a plurality of languages. The system 10 receives inputs indicative of the vocabulary questions answered correctly by the student the first time. The system 10 displays the plurality of vocabulary flash cards 150 to the student a second time. The vocabulary question on each vocabulary flash card 150 may be changed each time that the flash card is displayed. In some embodiments, each flash card 150 includes an illustration 154 associated with the vocabulary question. The illustration 154 associated with the vocabulary question may be changed each time that the flash card 150 is displayed. The system 10 receive inputs indicative of vocabulary questions answered correctly by the student the second time. The system 10 removes the vocabulary flash cards 150 having the vocabulary questions that have been answered correctly both the first time and the second time to create remaining flash cards. The system 10 displays the remaining flash cards to the student. The system 10 continues to display the remaining flash cards to the student until each of the vocabulary questions is answered correctly twice.

In another embodiment, the system 10 provides reading titles 390 for improving reading efficiency. The reading titles are organized based on 3-way differentiation. The standards for three-way differentiation include reading level, which may be determined by Lexile®, F&P Guided Reading, or BRA; content mastery level, which includes state standards 54, Common Core math, Common Core ELAR, and NGSS Science; and first language proficiency, which includes state standards, WIDA™, and ELPA21.

Students begin the reading program by taking two diagnostic tests to determine their reading level and English language proficiency level. This establishes the starting point for where the student will be placed into the course for these two dimensions. As students begin a new unit of study, the student takes a pre-test for this topic. This “content” pre-test places the student at the correct content level and/or may require them to first complete some foundational or background lessons (scaffolds 100) before proceeding with the core content lesson. Upon completion of the lesson, students take an assessment. If the student scores above 80%, the student's content and reading levels are adjusted upward before the student takes the next lesson. If the student scores from 70% to 80%, just the student's content level is adjusted. If the student scores below 70%, both the content and reading levels are adjusted downward one level. A dynamic, personalized learning pathway is created for the student and will automatically adjust as the student completes each lesson and the associated assessment.

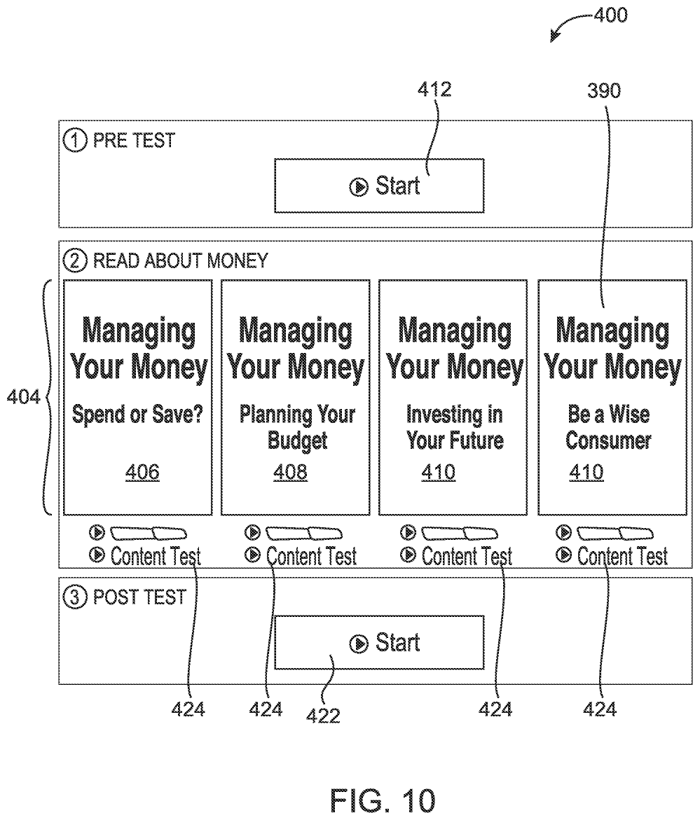

FIG. 10 illustrates a display 400 for testing reading efficiency. An icon 412 is selected for the student to start a diagnostic reading assessment to determine the student's reading level. Another diagnostic assessment determines the student's English language proficiency level. Teachers can select the student's first language in the student's profile. The student also takes a content pre-test within the specific subject and topic. Regardless of a student's specific reading or language proficiency level, the student may know some subjects well, but have limited knowledge in other subjects. The content pre-tests are given each time a new topic or unit of study is introduced. The diagnostic reading level test dynamically sets up the course to include four different reading levels 404. One book 406 is below the student's current reading level, one book 408 is at the student's current reading level, and two books 410 are above student's current reading level. The student starts the pre-test by selecting the icon 412. The content pre-test determines the personalized learning pathway for the student through the unit of study. If the pre-test results are below a certain threshold, the students will be presented with some foundation skills lessons or scaffold lessons 100 that must be completed first before the first reading level is unlocked. The student reads the book that is unlocked for them and completes the interactives within the book.

Then, the student reviews the vocabulary words 154 for the book using the icon 422. Once the student achieves 80% or better on the vocabulary review, the content test for that book is unlocked and can be accessed by selecting the icon 424. if the student scores 80% or better, the book for the next higher reading level is unlocked. The student continues to read the books and take the review tests until all of the reading level books are unlocked.

The content in the post test dynamically changes based on which books the student reads and completes. If a first level book is read, the student takes a 4 question post-test. If a second level book is read, the student takes a six question post-test. If a third level book is read, the student takes an eight question post-test. If a fourth level book is read, the student takes a 10 question post-test. The system 10 automatically adjusts the books and tests based on language differentiation and automatically presents targeted learning accommodations in the student's native language. The system 10 also automatically adjusts the difficulty level of the content based on the student's English language proficiency.

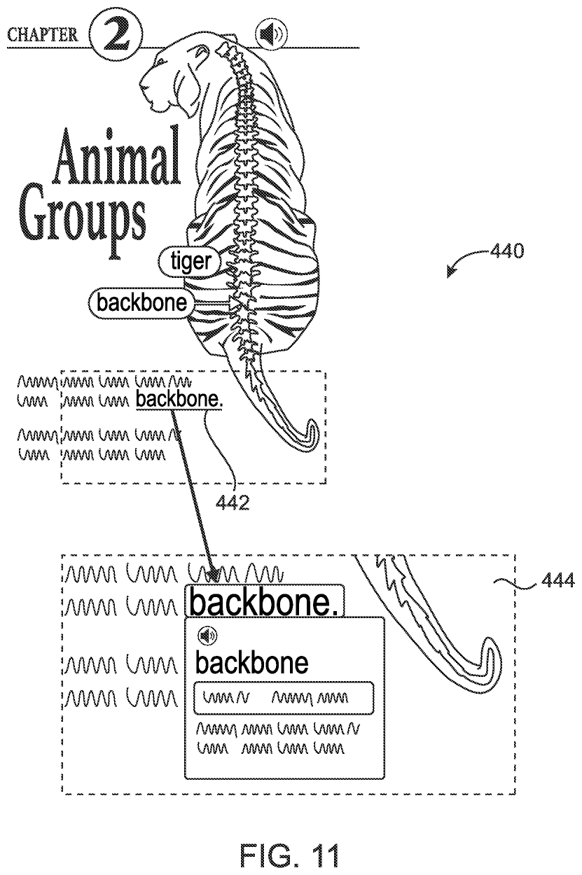

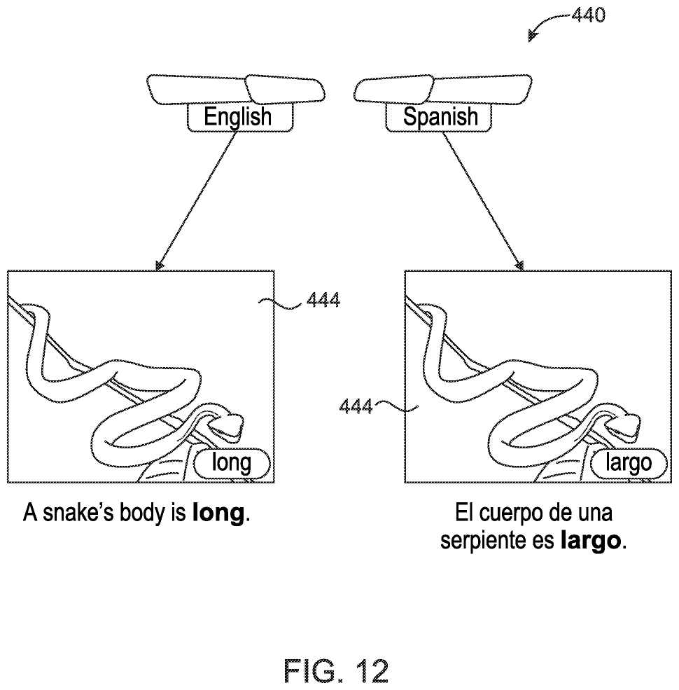

FIGS. 11 and 12 illustrate exemplary pages 440 from a reading title. While the student is reading or listening to the book, the student can click on the key ideas and key words 442 within the chapter. This displays a pop-up message 444 with a definition and translation of the word and the key idea in the student's native language. The language is selected by the teacher in the student's profile, which automatically displays the pop-ups for each student in their native tongue.

The student's reading level may be measured by national reading level scales. The student's content mastery level may be measured against state and national content standards 54. The student's English language proficiency level may be measured by English Language Development standards. The system 10 also includes a setting, which provides targeted support and translations for students in their native tongue or first language.

Overall, the system 10 facilitates improving reading efficiency by displaying a practice test to a student. The system 10 receives inputs indicative of the student's answers to questions on the practice test. The system 10 assigns a reading level to the student. The system 10 unlocks one of a plurality of a reading titles based on the reading level of the student. Each of the plurality of reading titles may be classified in one of a plurality of reading levels. The system 10 may unlock a reading title that corresponds to one of the plurality of reading levels. Each of the plurality of reading titles may be classified one of a plurality of subjects. Each of the plurality of subjects may include four reading titles, wherein each of the four reading titles classified within one of four reading levels. If the student completes the one of the plurality of reading titles, the system 10 unlocks a new reading title. The new reading title may be based on another reading level. In some embodiments, the reading titles may be displayed in a plurality of languages.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and many combinations of aspects and principles are possible in light of the various embodiments provided above.

1. A system for developing a lesson plan, the system comprising:
a processor comprising a computer-readable medium storing instructions configured to cause the processor, upon execution of the instructions to:
display a practice test to a student,
receive inputs indicative of the student's answers to questions on the practice test,
automatically tabulate a mastery percentage indicative of correct answers to the questions, and
output a lesson plan for the student, wherein the lesson plan is organized based on the mastery percentage.

2. The system of claim 1, wherein:
the questions on the practice test are based on a plurality of standards tested on a state assessment, and
wherein the lesson plan is organized based on the mastery percentage of each of the plurality of standards.

3. The system of claim 2, wherein:
the plurality of standards include a plurality of readiness standards and a plurality of supporting standards, and
the lesson plan is organized to separate the plurality of readiness standard and the plurality of supporting standards.

4. The system of claim 3, wherein:
the mastery percentage is indicative of a percentage of questions answered correctly for each of the plurality of standards, and
the lesson plan is organized so that the standards of the plurality of standards having a lower mastery percentage are given priority in the lesson plan.

5. The system of claim 4, wherein, if a readiness standard has the same mastery percentage as a supporting standard, the lesson plan is organized so that the readiness standard is given priority in the lesson plan.

6. The system of claim 4, wherein, if a first of the plurality of standards has the same mastery percentage as a second of the plurality of standards, the one of the first standard and the second standard that is more frequently tested on the state assessment is given priority in the lesson plan.

7. The system of claim 1, wherein the processor:
receives inputs indicative of a plurality of students answers to questions on the practice test, and
automatically tabulates a mastery percentage indicative of correct answers to the questions by each of the plurality of students.

8. A system for improving vocabulary efficiency, the system comprising:
a processor comprising a computer-readable medium storing instructions configured to cause the processor, upon execution of the instructions to:
display a plurality of vocabulary flash cards to a student a first time, wherein each of the plurality of vocabulary flash cards includes a vocabulary question,
receive inputs indicative of vocabulary questions answered correctly by the student the first time,
display the plurality of vocabulary flash cards to the student a second time,
receive inputs indicative of vocabulary questions answered correctly by the student the second time,
remove the vocabulary flash cards having the vocabulary questions that have been answered correctly both the first time and the second time to create remaining flash cards, and
display the remaining flash cards to the student.

9. The system of claim 8, wherein the processor continues to display the remaining flash cards to the student until each of the vocabulary questions is answered correctly twice.

10. The system of claim 8, further comprising an audio device, wherein the processor audibly transmits the vocabulary question through the audio device.

11. The system of claim 10, wherein the vocabulary questions are audibly transmitted in a plurality of languages.

12. The system of claim 8, wherein the vocabulary questions are displayed in a plurality of languages.

13. The system of claim 8, wherein the vocabulary question on each vocabulary flash card is changed each time that the flash card is displayed.

14. The system of claim 8, wherein:
each flash card includes an illustration associated with the vocabulary question, and
the illustration associated with the vocabulary question is changed each time that the flash card is displayed.

15. A system for improving reading efficiency, the system comprising:
a processor comprising a computer-readable medium storing instructions configured to cause the processor, upon execution of the instructions to:
display a practice test to a student,
receive inputs indicative of the students answers to questions on the practice test,
assign a reading level to the student, and
unlock one of a plurality of a reading titles based on the reading level of the student.

16. The system of claim 15, wherein:
each of the plurality of reading titles is classified in one of a plurality of reading levels, and
the processor unlocks a reading title that corresponds to one of the plurality of reading levels.

17. The system of claim 16, wherein:
each of the plurality of reading titles is classified one of a plurality of subjects, and
each of the plurality of subjects includes four reading titles, wherein each of the four reading titles classified within one of four reading levels.

18. The system of claim 15, wherein, if the student completes the one of the plurality of reading titles, the processor unlocks a new reading title.

19. The system of claim 18, wherein the new reading title is based on another reading level.

20. The system of claim 15, wherein the reading titles are displayed in a plurality of languages.
